(19) United States
(12) Patent Application Publication
(10) Pub. No.: US 2007/0076231 A1
(43) Pub. Date: Apr. 5, 2007

(54) Order processing apparatus and method for printing

(75) Inventor: Jun Enomoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/528,376

(22) Filed: Sep. 28, 2006

(30) Foreign Application Priority Data
Sep. 30, 2005 (JP) 2005-287246

(51) Int. Cl. G06F 3/12

(52) U.S. Cl. 358/1.2; 358/1.15

(57) ABSTRACT

An order processing apparatus is combined with a photographic printer, and processes an order of printing according to image data. Size reduced images are produced according to the image data. The size reduced images are displayed in a predetermined arrangement. A search query is entered. Retrieval information of the image data recorded in a storage medium is referred to according to the search query. Image data are selectively retrieved according to the search query among the image data. A size reduced image is displayed in association with the retrieved image data. Image data for use in printing is designated according to the displayed size reduced image. Furthermore, scene information of an image is entered. The image data are analyzed according to the scene information, so image data associated with a scene of the scene information are selectively retrieved.

### BACKGROUND OF THE INVENTION

1. Field of the Invention

The present invention relates to an order processing apparatus and method for printing. More particularly, the present invention relates to an order processing apparatus and method in which images to be printed can be selected and designated rapidly with great ease.

2. Description Related to the Prior Art

Images are picked up by use of a digital still camera. To place an order of printing the images to a photo shop, a storage medium is used to store image data of the images, examples of the storage medium including a smart media (trade name), xD picture card (trade name), and the like for use in the digital still camera. The storage medium is submitted to the photo shop when the order is placed. If a customer wishes printing or reprinting of images stored in CD-R or other types of the storage medium, the storage medium itself is submitted to the photo shop in placing an order. Then an order processing apparatus is operated in the photo shop by an attendant, is loaded with the storage medium. Selection of image frames for printing, the number of prints and the like are input according to the order. Thus, ordering information according to the selection and the number of prints is transmitted to a digital photo printer.

Furthermore, an automatic type of the order processing apparatus is known, and is installed at a store, photo shop, convenience store or the like, and can be accessed by a customer. He or she loads the order processing apparatus wit the storage medium storing image data. The ordering information, including the designation of the image frames, the number of prints and the like, is input for placing an order of printing.

Examples of the order processing apparatus are disclosed in JP-A 11-125867 and EP-A 1054556 (corresponding to JP-A 2000-321677). Image data is read from the storage medium, to display an index screen region of the image frames from the storage medium on a display panel. The ordering information is input by operating a user interface, such as a keyboard, mouse, touch panel display or the like, including designation of the image frames for printing, the number of prints, and the like.

There has been a recent tendency of enlargement of capacity of the storage medium in a small type, such as a memory card. It is expected in near future for one the memory card to have capacity of a number of gigabytes (GB). Consequently, one memory card will be able to store thousands of the image frames. However, a problem arises in considerable time and labor for seeking for and designating specific ones of the image frames of the great number stored in the memory card.

When the index screen region of the image frames is displayed on the display panel, the total number of the image frames displayable at one time is limited because the image frames should have a sufficiently large size observable for check. There is a problem in that the index screen region must be scrolled at considerably many times to seek for desired ones of the image frames among a great number of the image frames.

### SUMMARY OF THE INVENTION

In view of the foregoing problems, an object of the present invention is to provide an order processing apparatus and method in which images to be printed can be selected and designated rapidly with great ease.

In order to achieve the above and other objects and advantages of this invention, an order processing apparatus for processing an order of printing according to image data stored in a storage medium is provided, including a display panel, an image size reducing device for producing size reduced images according to the image data, and for causing the display panel to display the size reduced images in a predetermined arrangement, and a designating device for designating image data for use in the order of printing according to the size reduced images displayed on the display panel. In the order processing apparatus, an entering device enters a search query of chronological information of the image data. A retriever selectively retrieves image data according to the search query among the image data stored in the storage medium. A display control device causes the display panel to arrange and display a size reduced image in association with the retrieved image data.

The chronological information is information of a selected one of a date or time of image pickup of the image data, a date or time of digitalizing the image data, and a date or time of alteration of the image data.

The entering device further enters scene information of an image. The retriever further analyzes the image data according to the scene information, and selectively retrieves the image data associated with a scene of the scene information.

The entering device further enters at least one of object type information and scene type information. The retriever further discerns and retrieves image data according to at least one of the object type information and the scene type information.

The object type information is information of a selected one of a landscape, animal, plant and human being in an image portion of the image data. The scene type information is information of a night scene or daylight scene.

Also, in an order processing apparatus for processing an order of printing, an entering device enters a search query of an object type or scene type of the image data. An analyzer analyzes the image data, and for selectively retrieving image data according to the search query among the image data stored in the storage medium. A display control device causes the display panel to arrange and display a size reduced image in association with the retrieved image data.

Information of the object type is information of a selected one of a landscape, animal, plant and human being.

The information of the human being is information of a facial image of a specific person.

The analyzer selectively retrieves the image data containing information associated with the facial image by analyzing the image data.

Furthermore, a camera photographs a facial image of a person from whom the order is placed, to create information of the facial image of the specific person.

Information of the scene type is information of a night scene or daylight scene.

Also, in an order processing apparatus for processing an order of printing, an entering device enters a search query of at least one of chronological information, object type and scene type of the image data. An analyzer analyzes the image data, and for selectively retrieving image data according to the search query among the image data stored in the storage medium. A display control device causes the display panel to arrange and display a size reduced image in association with the retrieved image data.

Also, an order processing method of processing an order of printing according to image data stored in a storage medium is provided, in which size reduced images are produced according to the image data, and are displayed in a predetermined arrangement. In the order processing method, a search query of at least one of chronological information, object type and scene type of the image data is entered. The image data is analyzed, for selectively retrieving image data according to the search query among the image data stored in the storage medium, to designate the retrieved image data for a size reduced image to be arranged and displayed.

According to one aspect of the invention, an order processing user interface for processing an order of printing according to image data stored in a storage medium is provided. The user interface includes a size reducing region for displaying size reduced images produced according to the image data in a predetermined arrangement. An entering region is for entering a search query. A retrieving region is for referring to chronological information of the image data recorded in the storage medium according to the search query, and for selectively retrieving image data of at least one image according to the search query among the image data. A specific image size reducing region is for displaying a size reduced image in association with the retrieved image data. A designating region is for designating image data for use in printing according to the displayed size reduced image.

Also, an order processing user interface for processing an order of printing according to image data stored in a storage medium is provided. The user interface includes a size reducing region for displaying size reduced images produced according to the image data in a predetermined arrangement. An entering region is for entering scene information of an image. An analyzing region is for analyzing the image data according to the scene information, and for selectively retrieving image data associated with a scene of the scene information. A specific image size reducing region is for displaying a size reduced image in association with the retrieved image data. A designating region is for designating image data for use in printing according to the displayed size reduced image.

The scene information is reference information of a facial form of a specific person. The analyzing region includes a facial image analyzing area for analyzing the image data and for selectively retrieving portrait image data of an image containing a human facial form among the image data. An image recognizing area is for evaluating facial image information in the portrait image data by image recognition, and for selectively retrieving specific portrait image data of which the facial image information coincides with the reference information among the portrait image data.

Also, an order processing user interface for processing an order of printing according to image data stored in a storage medium is provided. The user interface includes a size reducing region for displaying size reduced image produced according to the image data in a predetermined arrangement. An entering region is for entering a search query. A retrieving region is for selectively retrieving image data of at least one image according to the search query among the image data stored in the storage medium in response to querying by inputting at least one of chronological information, object type information and scene type information in the entering device. A specific image size reducing region is for displaying a size reduced image in association with the retrieved image data. A designating region is for designating image data for use in printing according to the displayed size reduced image.

According to another aspect of the invention, an order processing computer executable program for processing an order of printing according to image data stored in a storage medium is provided. The computer executable program includes a size reducing program code for producing size reduced images according to the image data, and for displaying the size reduced images in a predetermined arrangement. An entering program code is for entering a search query. A retrieving program code is for referring to chronological information of the image data recorded in the storage medium according to the search query, and for selectively retrieving image data of at least one image according to the search query among the image data. A specific image size reducing program code is for displaying a size reduced image in association with the retrieved image data. A designating program code is for designating image data for use in printing according to the displayed size reduced image.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating an order processing apparatus and a printer in combination;

FIG. 2 is a block diagram illustrating the order processing apparatus;

FIG. 3 is a flow chart illustrating processing in the order processing apparatus;

FIG. 4 is a block diagram illustrating another preferred order processing apparatus in which facial images are recognized; and

FIG. 5 is a flow chart illustrating processing in the order processing apparatus.

### DETAILED DESCRIPTION OF THE PREFERRED EMBODIMENT(S) OF THE PRESENT INVENTION

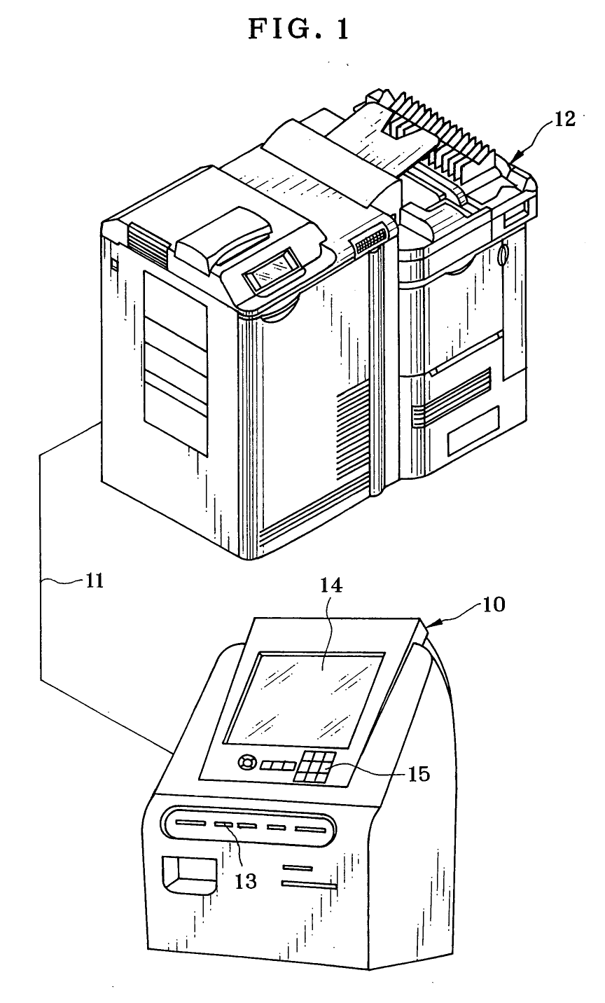

In FIG. 1, an order processing apparatus 10 is an automatic machine of a type installed in a photo shop or store. Image data is brought and input in a form stored in a memory card or other storage medium. The order processing apparatus 10 reads all image data from the memory card set in the slot, and displays all images in a screen region. A customer is allowed to designate images of his or her preference for printing. A photographic printer 12 is connected by a communication line 11 to the order processing apparatus 10. After the designation, the image data is transmitted to the photographic printer 12 through the communication line 11. Also, ordering information is transmitted together with plural image data. The photographic printer 12 produces photographic prints according to the image data.

The order processing apparatus 10 includes a card slot 13, a display panel 14 in a user interface, and a keypad 15. The display panel 14 displays various screen regions and information, such as an index screen region, a search screen region and the like. The keypad 15 as input devices for designation and entering in the user interface has various keys or buttons, such as a frame designating button, a start button, a search button, and keys of a ten-key pad for inputting numerical information as a search query.

Additional elements (not shown) may be incorporated in the order processing apparatus 10, for example, a ticket printer for printing a ticket or order sheet with information of an order number, price, and the like. Also, LAN (local area network) can be used to connect a plurality of the order processing apparatuses and a plurality of printers. To this end, digital image controller (DIC) is connected to the LAN. The DIC receives data transmitted from a plurality of the order processing apparatuses, determines an order or reception of data, and determines printers for use in outputting per each data. Also, images of the data can be processed by image processing. Conditions of the image processing are well-known in the art, for example, enlargement and reduction according to electronic zooming, correction of halftone, correction of color or density, correction of chroma, sharpness processing and the like.

The order processing apparatus 10 reads image data from a storage medium or memory card through the card slot 13, and produces size reduced images according to the image data, and causes the display panel 14 to display an image group in an index form in arrangement of two dimensions. Images to be printed are designated among those displayed, to produce prints.

If numerous images are recorded in the storage medium, one page of the index screen region cannot contain all the images. A plurality of pages must be used and changed over for viewing the images, to increase time for a customer to find out a desired image. In view of this, a search screen region is displayable and used for inputting search queries, to select image data of images only associated with the search queries. This facilitates the operation of designating images to be printed.

The order processing apparatus 10 has the display panel 14 and the keypad 15 to operate for various conditions in processing an order of printing, the display panel 14 indicating information in the manner of graphical user interface (GUI). It is to be noted that the display panel 14 may be a touch panel type. Also, the keypad 15 may be additionally used in combination with such a touch panel. Furthermore, the use of the keypad 15 and the touch panel can be selective by means of a suitable selector.

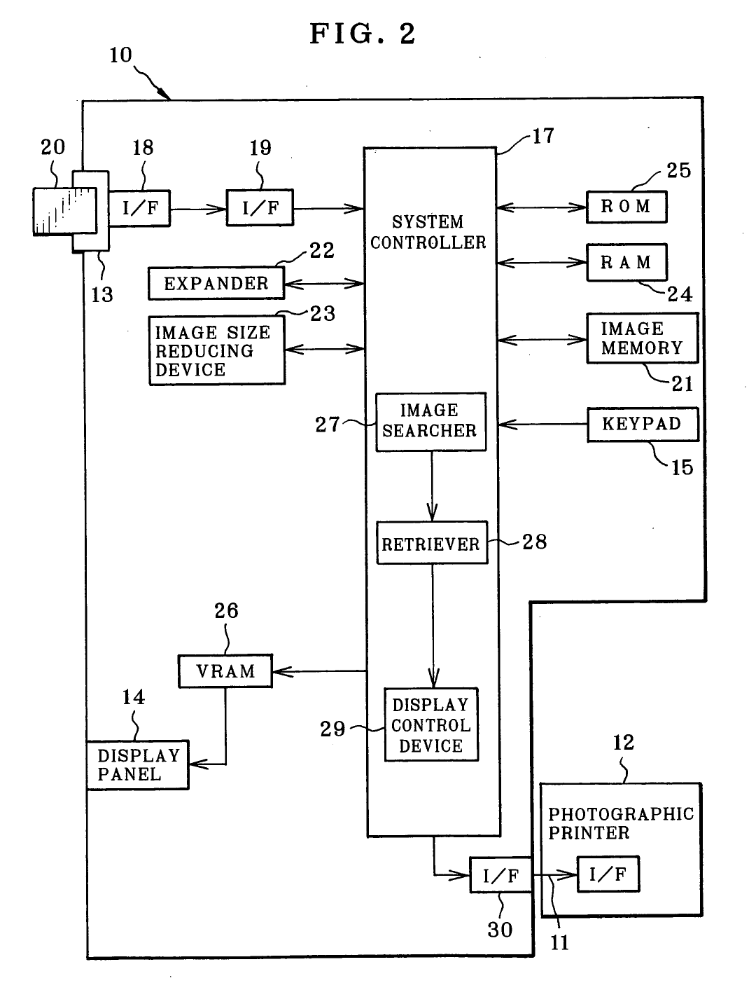

In FIG. 2, a system controller 17 controls relevant elements of the order processing apparatus 10. An interface or card reader 18 and an interface 19 are connected with the system controller 17 and are positioned in the card slot 13. A memory card 20 as data storage is inserted in the card slot 13 in a removable manner.

Various examples of storage media can be used. Also, acquisition of image files through the Internet or other communication network is usable. The order processing apparatus 10 may have a plurality of types of reading devices. Examples of storage media include smart media (trade name), xD picture card (trade name), compact flash (trade name), memory stick (trade name), SD media card (trade name), micro drive (trade name), CD-R (RW), MD, MO, flexible disk, ZIP, and the like.

An image memory or storage medium 21 is incorporated in the order processing apparatus 10, and stores image data read from the memory card 20. The image memory 21 also stores chronological information associated with image data for representing a date and/or time of image pickup. The state of the chronological information is kept inhibited from being rewritten in the image memory 21. The image memory 21 has a first region for storing image data read initially from the memory card 20, and a second region for storing size reduced image data for producing an index screen region.

An expander 22 and an image size reducing device 23 are connected with the system controller 17. The expander 22 as expanding region outputs an expanded form of information by expanding compressed image data. The image size reducing device 23 as image size reducing region reads image data from the image memory 21, analyzes an initial header portion at the start of the data, discerns a format of image data, and reads the image data according to the discerned format. The image size reducing device 23 produces image data by utilizing the same image data or by thinning the image data if required to resize the image data in consideration of a reduced size. The size reduced image is stored in the image memory 21. Note that, instead of the use of the image memory 21 before the size reduction of the image, it is possible to produce a size reduced image directly upon reading image data from the memory card 20. In response to a start signal for printing, image data of a designated image can be read from the memory card 20 and sent to the photographic printer 12 in a size reduced form.

To acquire size reduced images, data of thumbnail images may be utilized if prerecorded together with image data. The thumbnail image data may be written to the image memory 21 without changes. Furthermore, image data may be in a non compressed form without stored thumbnail images. For this form, the image data when read may be thinned in a suitable form for the size of the size reduced images. Alternatively, image data may be in a compressed form without stored thumbnail images. For this form, the image data may be expanded by the expander 22, and then subjected to resizing in a suitable form for the size of the size reduced images.

RAM 24, ROM 25 and the keypad 15 are connected with the system controller 17. The RAM 24 is a work memory. The ROM 25 stores a main control program, and subsidiary programs which are an image forming program, a search program and the like. The image forming program produces image data of an image group for arrangement on the display panel 14 according to size reduced image data in the image memory 21. A VRAM 26 (video random access memory) is provided with the image data for driving the display panel 14 to display. If the number of size reduced images is very great in view of the size of the one frame, a next page button indicia is displayed for a change to next page. It is possible in the panel to display numerous size reduced images one page after another. Note that image data of an image group may be produced in other manners, for example, a menu moving in a scrolling screen region.

A search button indicia is displayed in a corner portion of the entire screen region of the display panel 14 while size reduced images are displayed. When the search button indicia is clicked, the screen region is changed over, to display a search screen region. There are a search starting button indicia and box indicia for designating the chronological information of image pickup or a range of the chronological information. The keypad 15 is operated to input the chronological information of image pickup or a range of the chronological information in the box indicia, before the search starting button indicia is clicked selectively to retrieve image data associated with search query. Only size reduced images according to selectively retrieved image data are displayed on the display panel 14 as a result. It is preferable that the chronological information of image pickup may be constituted by plural digits for year, month and day and time.

The system controller 17 includes an image searcher 27, a retriever 28, and a display control device or specific image size reducing device 29. Those are operating units in the system controller 17 executing a search program. The image searcher 27 as image search region causes the display panel 14 to display a search screen region, and also reads a search query to send a retrieval signal to the retriever 28. The retriever 28 as retrieving region selects image data according to the search query by referring to chronological information of image data stored in the image memory 21, and sends a selective retrieval signal to the display control device 29, the selective retrieval signal being address information to identify the selectively retrieved image data. The display control device 29 as specific image size reducing region reads only images from the image memory 21 according to image data associated with the selective retrieval signal, and causes the display panel 14 to display those in the reduced size. In the screen region for the specific image as a result, there are check box indicia and number box indicia. The check box indicia is a region to input a signal as to whether an image should be printed or not. The number box indicia is a region to input a number of prints to be produced. Note that the number box indicia may be a well-known screen region of pull down menu or drop down menu, in which a list of values of the number of prints becomes indicated in a manner moving downward to appear.

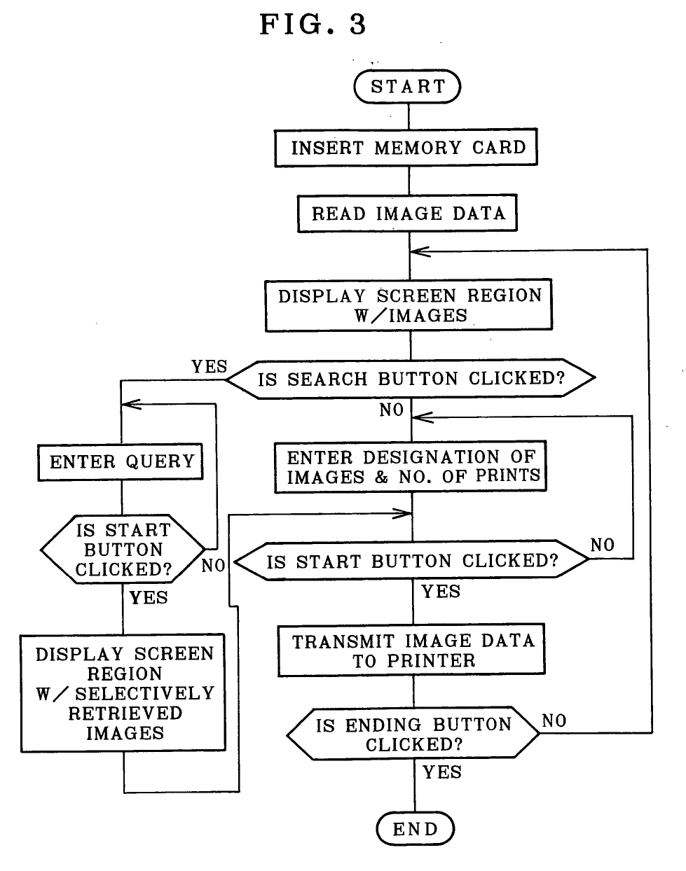

The operation of the embodiment is described by referring to FIG. 3. When the memory card 20 is inserted in the card slot 13, the system controller 17 reads all image data from the memory card 20, and writes them to the image memory 21. Note that a reading starting button indicia may be added and displayed on the screen region. The image data can start being read in response to clicking the reading starting button indicia. The image size reducing device 23 reads image data from the image memory 21 sequentially one after another, and produces size reduced image data, which is written to the image memory 21. The system controller 17 produces an image data file of index image data to display size reduced image data in an aligned manner. The image data file is output, so as to transmit the data to the VRAM 26. An index screen region is displayed on the display panel 14 to arrange a plurality of size reduced images.

Note that, in place of the index screen region, it is possible to indicate a top page with an index screen region button indicia and a screen region button indicia on the top page, the index screen region button indicia being depressible for displaying an index screen region. The screen region button indicia is depressible for return from the index screen region to the top page.

Size reduced images are displayed in the index screen region in an aligned manner. There are a check box indicia and a number box indicia displayed in association with each of size reduced images. The check box indicia is adapted to designating a start for printing. The number box indicia is adapted to inputting the number of prints to be produced. If the total number of the size reduced images is greater than that of images containable in one screen region, plural pages are used for displaying size reduced images. In a first page, a next page button indicia and search button indicia are displayed. In a final page, a previous page button indicia, the search button indicia and a first page button indicia are displayed. In each of intermediate pages, the previous page button indicia, next page button indicia and search button indicia are displayed.

When the search button is clicked, a search screen region is displayed. Indicia in the search screen region includes a query box indicia, a search starting button indicia, and a return indicia for return to an index screen region.

The chronological information of image pickup or a range of the chronological information is input in the query box indicia. The start button is clicked selectively to retrieve image data associated with the chronological information of image pickup or a range of the chronological information. Size reduced images associated with selectively retrieved image data are displayed on the display panel 14. If the total number of the size reduced images is excessively great, plural pages are used for displaying size reduced images.

In the screen region for the specific image as a result, there are check box indicia and number box indicia. The check box indicia is adapted to input a signal as to whether an image should be printed. The number box indicia is adapted to input a number of prints to be produced. Also, a size check box indicia may be added for designating a printing size. A sign of check for designation is input in the check box indicia. The number of prints is input in the number box indicia. After this, the start button is clicked. Image data of specific size reduced images are read from the image memory 21. An interface 30 is connected, through which the image data is transmitted to the photographic printer 12. Also, ordering information is produced, which includes file names of image data, numbers of prints of images, printing size of the images, and other information required for printing. The ordering information is transmitted together with image data.

When transmission of data to the photographic printer 12 is completed, an ending button indicia and an ordering screen button indicia are displayed on the display panel 14. When one of those button indicia is clicked, all image data in the image memory 21 are deleted as an end of the operation. When the ordering screen button indicia is clicked, the index screen region is displayed again for all size reduced images are displayed, to continue processing of an order.

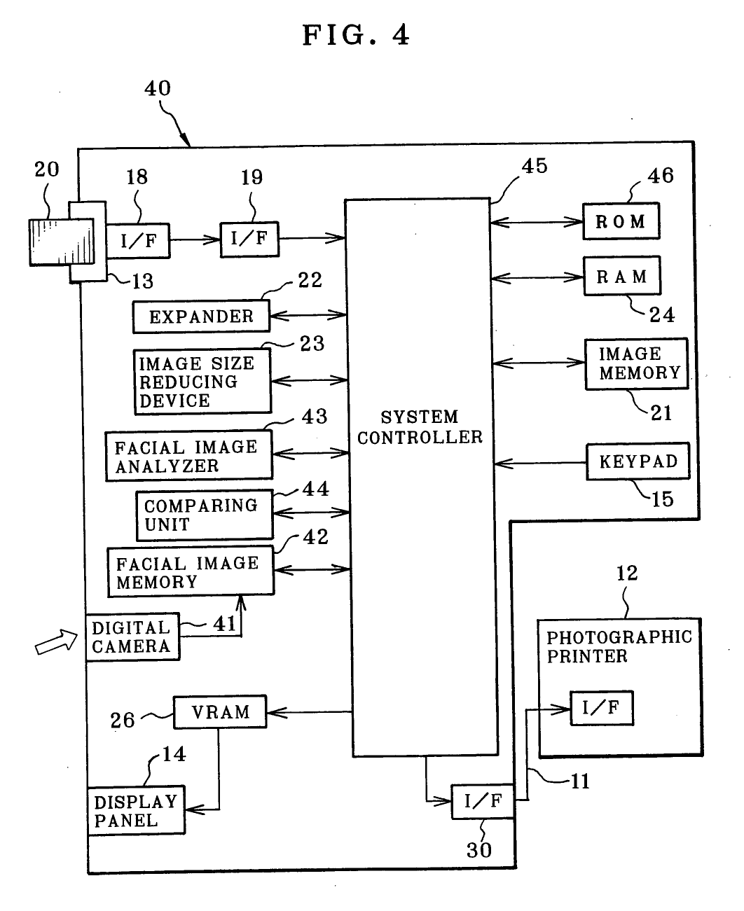

In FIG. 4, a preferred embodiment is illustrated, in which an image containing a face of a customer is searched and selected. An order processing apparatus 40 includes a digital camera 41 for image pickup, a facial image memory or storage medium 42, a facial image analyzer 43 as facial image analyzing unit, and an image recognizing or comparing unit 44 as image recognizing or comparing region. A system controller 45 controls elements including the facial image memory 42, the facial image analyzer 43 and the comparing unit 44 in connection therewith. Elements similar to those of FIG. 2 are designated with identical reference numerals.

The digital camera 41 has a window of an objective lens directed in the front of the order processing apparatus 40, for example disposed higher than the display panel 14. The digital camera 41 photographs a face of a customer. Image data obtained by the image pickup is written to the facial image memory 42. The facial image analyzer 43 of image analysis extracts reference facial image information from image data obtained by image pickup, and causes the image memory 21 temporarily to store the reference facial image information. Then the facial image analyzer 43 selectively retrieves portrait images with facial image information among images of image data read from the image memory 21, and writes image data of the portrait images to the image memory 21 in a temporary manner. It is possible in the reading to skip image data of images in which a facial image portion is not contained. The comparing unit 44 for image recognition compares facial image information in each of all portrait images with the reference facial image information, and selectively designates coinciding specific portrait images among the portrait images. Information of the specific portrait images is transmitted to the system controller 45. Only image data of the specific portrait images are caused by the system controller 45 to output to the display panel 14 for indication of a result.

As described heretofore, all image data in the data storage is read initially, and written to the image memory 21. Then size reduced images are produced. An index screen region with those is displayed. A search button indicia is displayed on the index screen region. This is clicked to change over the screen region to a search screen region. A specific face search button indicia appears in the search screen region for searching image data with a facial image of the customer. ROM 46 stores a facial image analyzing program, which is run in response to depressing the specific face search button indicia.

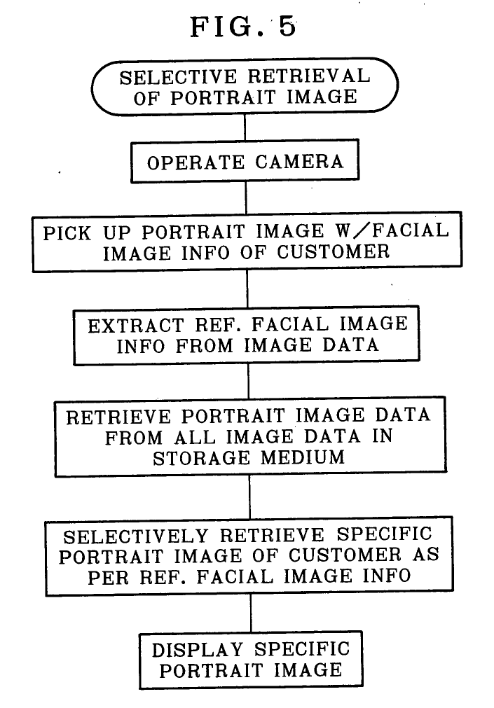

When the facial image analyzing program is started, the digital camera 41 is operated as shown in FIG. 5. Image data is sent to the VRAM 26 to cause the display panel 14 to display a live image. A user or customer views the live image, and adjusts the position of his or her face for setting in a frame. A confirmation button is clicked on one portion of the screen region. In response, still image data of a portrait image is retrieved and output by the digital camera 41, and written to the facial image memory 42. The facial image analyzer 43 selectively retrieves facial image information according to portrait image data read from the facial image memory 42, and writes the extracted facial image information to the image memory 21 in a temporarily stored manner as reference facial image information.

The facial image analyzer 43 is controlled by the system controller 45 selectively to retrieve portrait images with facial image information among images of all image data in the image memory 21. The portrait images are written to the image memory 21 in a temporary manner. The comparing unit 44 for image recognition compares portrait images with reference facial image, and selects specific portrait images in which a face of the user coincides the stored face. The selected specific portrait images with facial image information are indicated on the display panel 14 as an index screen region as a list of size reduced images of the image data.

In the present embodiment, the digital camera 41 is used. However, previously obtained image data may be stored in a storage medium, and may be input by reading in the order processing apparatus 40 for registering reference facial image information. Also, it is possible selectively to retrieve portrait image data with faces among image data stored in the storage medium, to produce size reduced images according to the selectively retrieved image data for an index indication, and to register reference image data for use in the search. Furthermore, selective retrieval of image data of portrait images with facial image information may be eliminated. Size reduced images of all image data can be displayed in an index manner, so a customer can be allowed to designate images of image data to be searched.

In the above embodiment, image data is analyzed and retrieved according to the facial image coinciding with a reference facial image. However, other search queries may be used instead of the facial image, such as a landscape, plant, animal or pet, and person, and scene types of various time zones for night scene, daylight scene or the like, and combinations thereof. To this end, query box indicia is indicated in a pull down form of a screen region for designating one of preset scene types. For types of photographic objects, it is possible to discern images according to plural patterned images, to discern image data of a landscape, plant, animal or pet, and person. For scene types, it is possible to discern images according to brightness in image data, threshold values of hue, or the like as scene type information, to discern image data of daylight image, night image, an early evening image of dim light, and the like.

For discernment of portrait images among images, and for image recognition of a specific facial image, any suitable known techniques can be utilized for the facial image analyzer 43 and the comparing unit 44 in the field of electronic imaging.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An order processing apparatus for processing an order of printing according to image data stored in a storage medium, said order processing apparatus including a display panel, an image size reducing device for producing size reduced images according to said image data, and for causing said display panel to display said size reduced images in a predetermined arrangement, and a designating device for designating image data for use in said order of printing according to said size reduced images displayed on said display panel, said order processing apparatus comprising:
an entering device for entering a search query of chronological information of said image data;
a retriever for selectively retrieving image data according to said search query among said image data stored in said storage medium; and
a display control device for causing said display panel to arrange and display a size reduced image in association with said retrieved image data.

2. An order processing apparatus as defined in claim 1, wherein said chronological information is information of a selected one of a date or time of image pickup of said image data, a date or time of digitalizing said image data, and a date or time of alteration of said image data.

3. An order processing apparatus for processing an order of printing according to image data stored in a storage medium, said order processing apparatus including a display panel, an image size reducing device for producing size reduced images according to said image data, and for causing said display panel to display said size reduced images in a predetermined arrangement, and a designating device for designating image data for use in said order of printing according to said size reduced images displayed on said display panel, said order processing apparatus comprising:
an entering device for entering a search query of an object type or scene type of said image data;
an analyzer for analyzing said image data, and for selectively retrieving image data according to said search query among said image data stored in said storage medium; and
a display control device for causing said display panel to arrange and display a size reduced image in association with said retrieved image data.

4. An order processing apparatus as defined in claim 3, wherein information of said object type is information of a selected one of a landscape, animal, plant and human being.

5. An order processing apparatus as defined in claim 4, wherein said information of said human being is information of a facial image of a specific person.

6. An order processing apparatus as defined in claim 5, wherein said analyzer selectively retrieves said image data containing information associated with said facial image by analyzing said image data.

7. An order processing apparatus as defined in claim 6, wherein said Furthermore, a camera photographs a facial image of a person from whom said order is placed, to create information of said facial image of said specific person.

8. An order processing apparatus as defined in claim 3, wherein information of said scene type is information of a night scene or daylight scene.

9. An order processing apparatus for processing an order of printing according to image data stored in a storage medium, said order processing apparatus including a display panel, an image size reducing device for producing size reduced images according to said image data, and for causing said display panel to display said size reduced images in a predetermined arrangement, and a designating device for designating image data for use in said order of printing according to said size reduced images displayed on said display panel, said order processing apparatus comprising:
an entering device for entering a search query of at least one of chronological information, object type and scene type of said image data;
an analyzer for analyzing said image data, and for selectively retrieving image data according to said search query among said image data stored in said storage medium; and
a display control device for causing said display panel to arrange and display a size reduced image in association with said retrieved image data.

10. An order processing method of processing an order of printing according to image data stored in a storage medium, in which size reduced images are produced according to said image data, and are displayed in a predetermined arrangement, said order processing method comprising steps of:
entering a search query of at least one of chronological information, object type and scene type of said image data; and
analyzing said image data, for selectively retrieving image data according to said search query among said image data stored in said storage medium, to designate said retrieved image data for a size reduced image to be arranged and displayed.
